(19) United States
(12) Patent Application Publication
(10) Pub. No.: US 2009/0297703 A1
(43) Pub. Date: Dec. 3, 2009

(54) INDUCED PHASE COMPOSITE TRANSPARENT HARD COATING

(75) Inventors: Hao Li, Chandler, AZ (US); Yi Wei, Chandler, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 12/128,982

(22) Filed: May 29, 2008

(51) Int. Cl. B05D 5/06

(52) U.S. Cl. 427/163.3

(57) ABSTRACT

A method of forming a protective layer on a substrate (202) such as glass includes depositing an a magnesium oxide layer (108, 208) and amorphous oxide material (106, 206) on the substrate (202), either simultaneously or in succession, and at a temperature below 300 degrees Centigrade. The amorphous oxide layer (106, 206) may crystallize in some embodiments when deposited.

### FIELD

The present invention generally relates to a transparent hard coating and more particularly to a method and material for coating a lens or housing of portable electronic devices.

### BACKGROUND

The market for personal portable electronic devices, for example, cell phones, laptop computers, personal digital assistants (PDAs), digital cameras, and music playback devices (MP3), is very competitive. Manufacturers, distributors, service providers, and third party providers have all attempted to find features that appeal to the consumer. Manufacturers are constantly improving their product with each model in the hopes it will appeal to the consumer more than a competitor's product. Many times these manufacturer's improvements do not relate directly to the functionality of the product.

The look and feel of personal portable electronics devices is now a key product differentiator and one of the most significant reasons that consumers choose specific models. From a business standpoint, outstanding designs (form and appearance) may increase market share and margin.

The widespread use of portable electronic devices such as cell phones, personal data assistants, and digital media players has resulted in two trends. The first trend is the use of larger displays and the increase in the use of glass or a thermoplastic as a transparent display cover. While these layers have excellent transparency and are physically strong, they suffer both aesthetic and functional degradation due to scratches, scuffing, abrasions and the like. The other trend is the use of very high gloss materials for the housing with a focus on the aesthetic appeal of the device, which suffers a similar aesthetic and functional degradation due to scratches, scuffing, abrasions and the like. This is particularly true for products which receive significant handling, such as persona data assistants (PDAs) and cell phones. This has led to the result that any type of scratches, scuffing, or abrasions is especially undesirable as it tends to be very noticeable and can degrade both the functional and aesthetic performance of the device. This degradation may also lead to breakage of the display cover.

An amorphous material is generally too soft to serve as a coating as it is susceptible to scratching. A crystalline material is harder (scratch resistant), but typically requires an undesirable high temperature during formation.

Many materials have been mentioned for use as hard coatings. A single layer ceramic coating including Al₂O₃, ZrO₂, and DLC (amorphous diamond like carbon) is most common. Al₂O₃, commercially available as coatings of, for example, cutting tools, is hard and chemically inert, and is excellent as an anti-oxidation coating for high temperatures. It has a smooth surface with minimum friction and very low optical absorption in the visible range extending to ultraviolet. Corundum, the most stable phase of Al₂O₃, has a high hardness but requires a deposition temperature as high as 1000 degrees C., which is too high for coatings of electronic devices and leads to significant thermal stress. ZrO₂ requires stabilization. DLC has issues with the ability to control bonding, adhesion to substrates, and absorption in the visible range. Composite layers include TiN+SiN which is not transparent, SiO₂/resin which is a DVD coating, and Al₂O₃/SiO₂/poly which is used on wood floors. Multilayer/Superlattice materials include SiON/polymer/SiON (an OLED encapsulation) as a permeation barrier and Ti/Zr/N (on cutting tools) which is non-transparent.

Typical films deposited at low temperatures are amorphous even though their crystalline phases have lower energy. High temperature is normally required to overcome this energy barrier to form crystalline phases.

Accordingly, it is desirable to provide a coating material that forms a crystalline phase at a low temperature, and is transparent. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIG. 1 is a partial cross section of a first exemplary embodiment;

FIG. 2 is partial cross section of a second exemplary embodiment;

FIG. 3 is a picture of an MgO layer subsequent to being subjected to a pressure points impact test;

FIG. 4 is a picture of an Al₂O₃ layer subsequent to being subjected to a pressure points impact test; and

FIG. 5 is a picture of a layer formed in accordance with the first exemplary embodiment subsequent to being subjected to a pressure points impact test.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

An induced phase composite provides the required hardness for coating another material to protect against scratching while requiring a low processing temperature. The atomic bonding (length, direction, and type) dictates the hardness of the coating. In a first exemplary embodiment, a magnesium oxide (MgO) material may be disposed simultaneously with another transparent oxide at room temperatures to form a poly crystalline film or crystallites in an amorphous matrix on the substrate material. In a second exemplary embodiment, a thin layer of the MgO may be deposited on the substrate as a seed layer and a subsequent layer of the transparent oxide may be deposited on the MgO layer. The MgO layer crystallizes when formed and causes the transparent oxide to crystallize as it is formed.

Amorphous materials typically have higher energy than crystalline material. A high temperature is needed to overcome the energy barrier existing between the amorphous state and the crystalline state in order to convert the amorphous material to a crystalline material.

There are two methods disclosed herein to overcome this energy barrier. One method is to increase the energy of the film forming particles by, for example, plasma, ion assist, pulsed laser, and a substrate bias cathodic arc. A second method is to decrease the nucleation energy by providing a crystalline template by providing a seeding layer. A combination of these two methods may be used.

Referring to FIG. 1, the layer 102, having a surface 104, may be glass or a polymer serving as any type of substrate or surface such as a lens, a protective cover, and a housing. A transparent oxide 106, for example alumina (Al₂O₃) or zirconia (ZrO₂), or a mixture of Al2O3 and ZrO2, and a MgO material 108 are co-deposited onto the surface 104 as a film 112. The MgO material 108 forms a plurality of crystallites 110 within the film 112.

The application of the transparent oxide 106 and the MgO material 108 is made at a temperature generally in the range of 20 to 300 degrees Centigrade and more preferably at room temperature (between 25 to 27 degrees Centigrade) to a thickness of between 100 nanometers to 5000 nanometers, and preferably to a thickness of about 500 nanometers. The transparent oxide 106 and MgO material 108 are applied wherein the MgO occupies approximately 5% to 95% by volume.

Though the transparent oxide 106 is amorphous when applied, it may crystallize in contact with the MgO material 108, or remain amorphous, resulting in a transparent composite material 112.

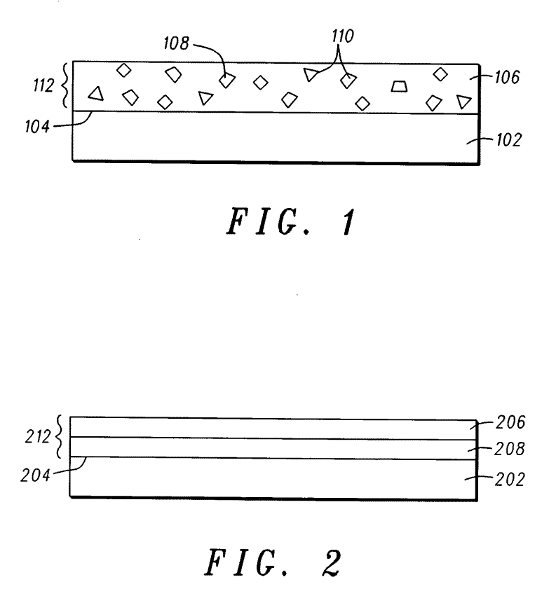

Referring to FIG. 2, a second embodiment includes a substrate 202 having a surface 204, which may be glass or a polymer serving as any type of substrate or surface such as a lens, a protective cover, and a housing. An MgO material 208 is deposited onto the surface 204 and a transparent oxide 206 is deposited on the MgO material 208. The MgO material 208 provides a template for the growth of the transparent hard coating such as Al₂O₃ or ZrO₂. The transparent oxide layer 206 can be, for example alumina (Al₂O₃) or zirconia (ZrO₂), or a mixture of Al₂O₃ and ZrO₂, it can also includes MgO similar to the first embodiment layer 106.

The application of the transparent oxide 206 and the MgO material 208 is made at a temperature generally in the range of 20 to 50 degrees Centigrade and more preferably at room temperature (between 25 to 27 degrees Centigrade). The MgO material 208 generally has a thickness of between 1 nanometers and 1000 nanometers, and preferably has a thickness of about 50 nanometers. The transparent oxide 206 generally has a thickness of between 100 nanometers and 5000 nanometers, and preferably has a thickness of about 500 nanometers and a hardness above 10 GPa.

The MgO material 208 crystallizes when deposited. Though the transparent oxide 106 is amorphous when applied, it may crystallize in contact with the MgO material 108, resulting in transparent crystalline oxide/MgO layers 212, or form a crystallites-amorphous matrix.

The driving force for crystallization of an amorphous material comes from the lowering of the potential energy of the atoms or molecules when they form bonds to each other (the length, direction, and type of bonding determines hardness). Crystalline growth, by physical vapor transport for example, occurs when several atoms or molecules start forming clusters when the bulk free energy of the cluster is less than that of the host material. When the cluster has a radius greater than a critical radius, the cluster will increase in size by the addition of more atoms. The critical radius defines a critical energy barrier between the amorphous and crystalline states that must be overcome. The amorphous material may be converted to a crystalline material by overcoming the energy barrier by increasing the energy of the film forming particles, for example, by application of plasma, ion assist, a pulsed laser, or substrate bias cathodic arc. However, these methods are difficult to control and may not always overcome the energy barrier. Alternatively, the nucleation energy may be decreased by providing a crystalline template in accordance with the exemplary embodiments described herein.

This combination of materials, a first transparent oxide that crystallizes upon deposition at temperatures below 300 degrees Centigrade and a second transparent oxide having a hardness above 10 GPa, provides a high hardness for abrasion resistance, a low visible light absorption for optical transparency, and a low temperature (less than 300 degrees Centigrade) deposition.

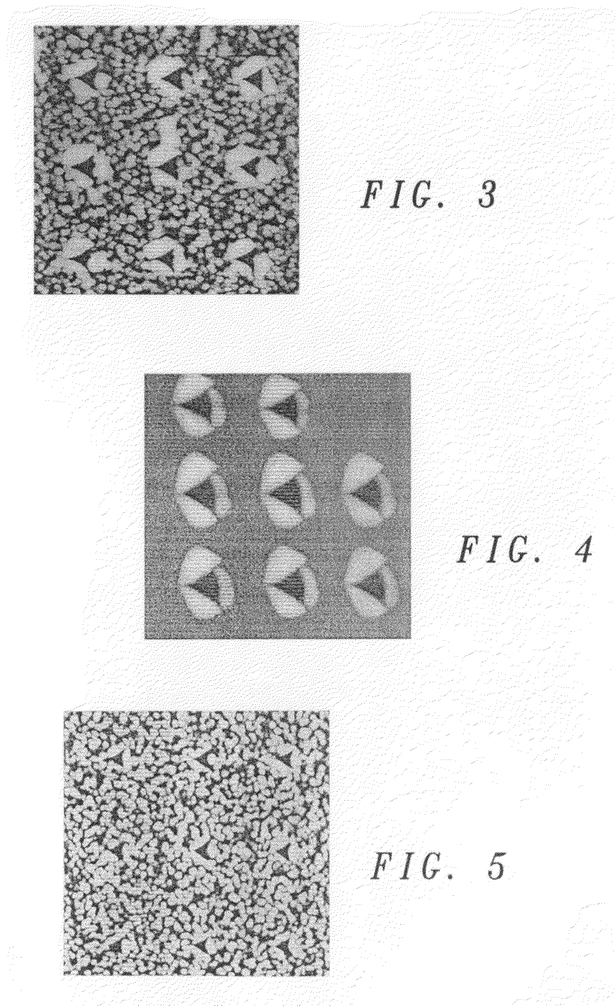

FIGS. 3-5 demonstrate the hardness of MgO, Al₂O₃, and the induced composite of MgO/Al₂O₃, respectively. The three respective materials were subjected to a nanoindent test by applying diamond points under the same pressure. It may be seen that the induced composite material provides the best results: the diamond points have less of an influence in modifying the surface of the induced composite of MgO/Al₂O₃.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method of forming a transparent coating, comprising:
depositing at a temperature below 300 degrees centigrade a first transparent oxide that crystallizes upon deposition; and
depositing a second transparent oxide having a hardness above 10 GPa.

2. The method of claim 1 wherein the depositing a second transparent oxide occurs subsequent to the depositing a first transparent oxide.

3. The method of claim 1 wherein the depositing a second transparent oxide occurs simultaneously with the depositing a first transparent oxide.

4. The method of claim 1 wherein the depositing a second transparent oxide further comprises depositing a third transparent oxide having a hardness above 10 GPa simultaneously with the second transparent oxide.

5. The method of claim 1 wherein the depositing a second transparent oxide further includes depositing the first transparent oxide.

6. The method of claim 1 wherein the depositing a second transparent oxide comprises depositing one of the oxides selected from the group consisting of Al₂O₃ and ZrO₂.

7. The method of claim 6 wherein the depositing a second transparent oxide further includes depositing MgO.

8. The method of claim 1 wherein the depositing a first transparent oxide comprises depositing MgO.

9. The method of claim 6 wherein the depositing a second transparent oxide comprises depositing a combination of Al₂O₃ and ZrO₂.

10. A method of forming a hard transparent film on a substrate, comprising:
forming a transparent oxide material having a hardness greater than 10 GPa on a substrate and adjacent to a magnesium oxide material.

11. The method of claim 10 wherein the forming step comprises applying an amorphous oxide that crystallizes as the transparent crystalline material when it is formed.

12. The method of claim 11 wherein the applying step comprises:
applying the amorphous oxide selected from one of the materials consisting of alumina or zirconia.

13. The method of claim 10 wherein the forming step comprises:
forming at a temperature in the range of 20 to 300 degrees Centigrade.

14. The method of claim 10 wherein the forming step comprises:
forming at a temperature in the range of 20 to 30 degrees Centigrade.

15. The method of claim 10 wherein the forming step comprises:
forming a plurality of magnesium oxide nano-crystallites within an amorphous material, wherein the amorphous material crystallizes as it forms on the substrate.

16. The method of claim 10 wherein the forming step comprises:
forming on the substrate a crystalline magnesium oxide layer as the magnesium material; and
forming on the crystalline magnesium oxide layer an amorphous layer, wherein the amorphous layer crystallizes to become the crystalline material.

17. The method of claim 16 wherein the forming a crystalline magnesium oxide layer and the forming an amorphous layer both comprise:
forming at a temperature in the range of 20 to 50 degrees Centigrade.

18. The method of claim 16 wherein the forming a crystalline magnesium oxide layer and the forming an amorphous layer both comprise:
forming at a temperature in the range of 25 to 27 degrees Centigrade.

19. A method of forming a protective layer on glass, comprising:
forming on the glass at a temperature in the range of 20 to 50 degrees Centigrade a transparent crystalline layer comprising an amorphous oxide and magnesium oxide, wherein the amorphous oxide crystallizes when contacted by the magnesium oxide.

20. The method of claim 19 wherein the forming step comprises depositing one of the oxides selected from the group consisting of Al₂O₃ and ZrO₂.

21. The method of claim 19 wherein the forming step comprises depositing a combination of Al₂O₃ and ZrO₂.

22. The method of claim 19 wherein the forming step comprises applying an amorphous oxide that crystallizes as the transparent crystalline material when it is formed.
